(19) United States
(12) Patent Application Publication
(10) Pub. No.: US 2012/0020626 A1
(43) Pub. Date: Jan. 26, 2012

(54) Optical Fiber Connector

(75) Inventor: Masahiro TANAZAWA, Kawaguchi-shi (JP)

(73) Assignee: Enplas Corporation, Kawaguchi-shi (JP)

(21) Appl. No.: 13/188,314

(22) Filed: Jul. 21, 2011

(30) Foreign Application Priority Data
Jul. 26, 2010 (JP) 2010-167222

(51) Int. Cl. G02B 6/42

(52) U.S. Cl. 385/79

(57) ABSTRACT

The invention improves work efficiency of assembly from that of the past, and suppresses decrease in coupling efficiency between an optical fiber and a photoelectric conversion element.

An optical fiber connector is composed of two components: an optical system component, such as an optical fiber attachment hole and a convex lens, having an area related to an optical system; and a holder, such as a bottom flat surface of a stopper receiving section, a male screw, and a flange, having an area unrelated to the optical system. The optical fiber connector is formed by the optical system component being assembled to the holder.

### TECHNICAL FIELD

The present invention relates to an optical fiber connector to which an optical fiber is attached that optically couples the optical fiber and a photoelectric conversion element using a lens.

### BACKGROUND ART

In recent years, as speed and capacity of data communication increase, optical communication by which optical signals are transmitted between an optical fiber and a photoelectric conversion element (light-emitting element or light-receiving element) has rapidly grown in popularity.

In optical communication, an optical fiber connector is used that fixes the optical fiber and the photoelectric conversion element, and optically couples the optical fiber and the photoelectric conversion element using a lens.

A tip end portion of the optical fiber is housed within an optical plug to attach the optical fiber to the optical fiber connector. The optical plug has a circular-cylindrical ferrule having a through hole in the center. The tip end portion of the optical fiber is set within the through hole.

On the other hand, the optical fiber connector is provided with an optical fiber attachment hole for housing the ferrule of the optical fiber. In addition, the optical fiber connector is also provided with a photoelectric conversion element housing section for housing the photoelectric conversion element.

In a state in which the optical fiber and the photoelectric conversion element are fixed, the optical fiber connector converges light emitted from the tip end of the optical fiber by a lens and emits the converged light to the photoelectric conversion element (light-receiving element), and converges light emitted from the photoelectric conversion element (light-emitting element) by the lens and emits the converged light to the tip end of the optical fiber.

In the conventional optical fiber connector (receptacle), the material used for the lens often differs from that of other sections (main body). After the lens and the main body are formed separately, the lens is assembled to the main body, thereby manufacturing the optical fiber connector (refer to Patent Literature 1).
Patent Literature 1: Japanese Patent Laid-open Publication No. Heisei 7-63948

### DISCLOSURE OF INVENTION

### Problem to be Solved by the Invention

Here, to increase optical coupling efficiency between the optical fiber and the photoelectric conversion element, an axial line (center line) of the ferrule of the optical fiber and the optical axis of the lens of the optical fiber connector are required to be positioned with high accuracy.

Therefore, the optical fiber attachment hole of the optical fiber connector is required to be formed with high accuracy such that its inner diameter is almost the same size as the outer diameter of the ferrule and its center line is aligned with the optical axis of the lens.

However, in the conventional technology disclosed in Patent Literature 1, the lens is a separate body from the main body including the optical fiber attachment hole. Therefore, when the lens is assembled to the main body, centering operation to align the optical axis of the lens and the center line of the optical fiber attachment hole is difficult, and a problem occurs in that work efficiency is poor.

In addition, in the conventional technology, because a flange and the optical fiber attachment hole are integrally manufactured, the optical fiber attachment hole tends to become deformed when stress is applied to the flange, and the coupling efficiency between the optical fiber and the photoelectric conversion element may decrease.

The present invention has been achieved in light of the above-described issues. An object of the present invention is to provide an optical fiber connector capable of improving work efficiency of assembly from that of the past, and suppressing decrease in coupling efficiency between an optical fiber and a photoelectric conversion element.

### Means for Solving Problem

An optical fiber connector of the present invention includes: a lens that optically couples an optical fiber and a photoelectric conversion element; an optical fiber attaching section for housing a ferrule of the optical fiber; and a flange for fixing the optical fiber connector to another device. The optical fiber connector is composed of: an optical system component including the optical fiber attaching section and the lens, and having an area related to an optical system; and a holder including the flange and having an area unrelated to the optical system. The optical fiber connector is formed by the optical system component being assembled to the holder.

Furthermore, in the optical fiber connector of the present invention, the optical system component is formed by a resin material having light transmittance being injection-molded.

### Effect of the Invention

According to the present invention, an optical fiber attachment hole and a lens can be integrally formed. Therefore, a centering operation for aligning an optical axis of the lens and a center line of the optical fiber attachment hole becomes unnecessary during assembly, and work efficiency can be improved from that of the past.

In addition, according to the present invention, because the optical fiber attachment hole and the lens are independent of a flange, the optical fiber attachment hole and the lens do not easily deform even when stress is applied to the flange, and decrease in coupling efficiency can be suppressed.

### BRIEF DESCRIPTION OF DRAWINGS

FIG. 1 is a front view of an optical fiber connector according to an embodiment of the present invention.

FIG. 2 is a side view of the optical fiber connector according to the embodiment of the present invention.

FIG. 3 is a front cross-sectional view of the optical fiber connector according to the embodiment of the present invention.

FIG. 4 is a cross-sectional view of a front portion of an optical fiber cable attached to the optical fiber connector according to the embodiment of the present invention.

FIG. 5 is a front cross-sectional view of an optical system component of the optical fiber connector according to the embodiment of the present invention.

FIG. 6 is a front cross-sectional view of a holder of the optical fiber connector according to the embodiment of the present invention.

FIG. 7 is a front cross-sectional view of a variation 1 of the optical fiber connector according to the embodiment of the present invention.

FIG. 8 is a front cross-sectional view of a variation 2 of the optical fiber connector according to the embodiment of the present invention.

FIG. 9 is a cross-sectional view of a front portion of a variation 3 of the optical fiber connector according to the embodiment of the present invention.

### EXPLANATIONS OF LETTERS OR NUMERALS

### Best Mode(s) for Carrying Out the Invention

An embodiment of the present invention will hereinafter be described in detail with reference to the drawings.

[Configuration of Optical Fiber Connector]

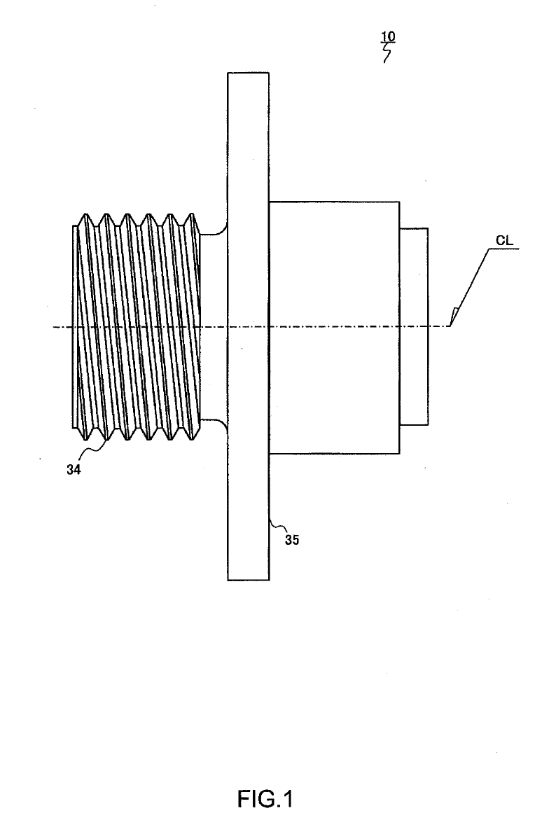

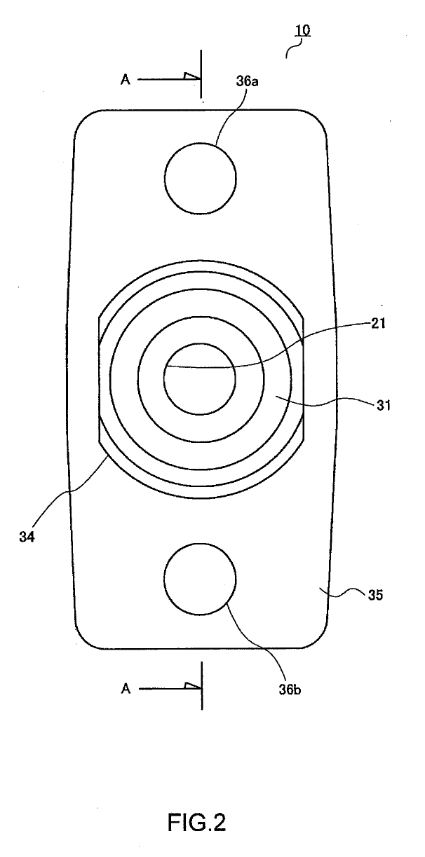

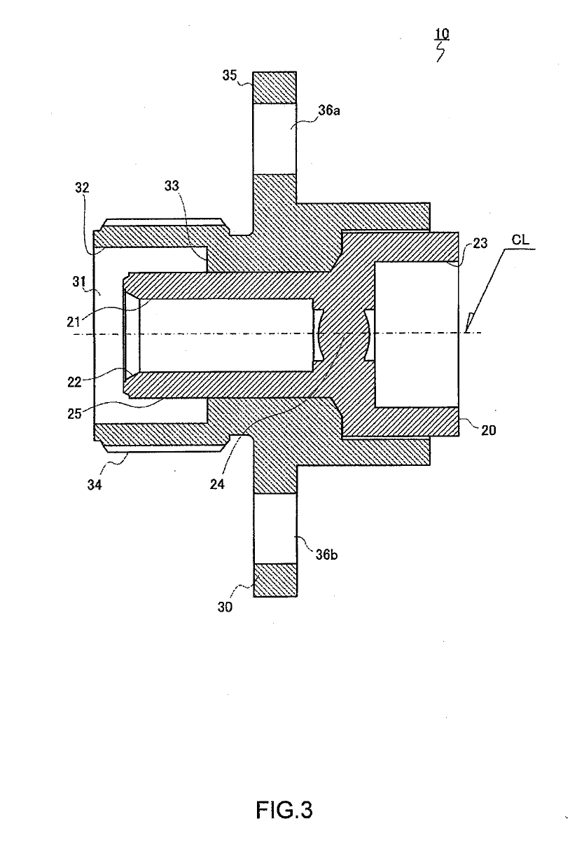

FIG. 1 to FIG. 3 are diagrams of an optical fiber connector according to the embodiment of the present invention. FIG. 1 is a front view, FIG. 2 is a side view, and FIG. 3 is a cross-sectional view taken along line A-A in FIG. 2.

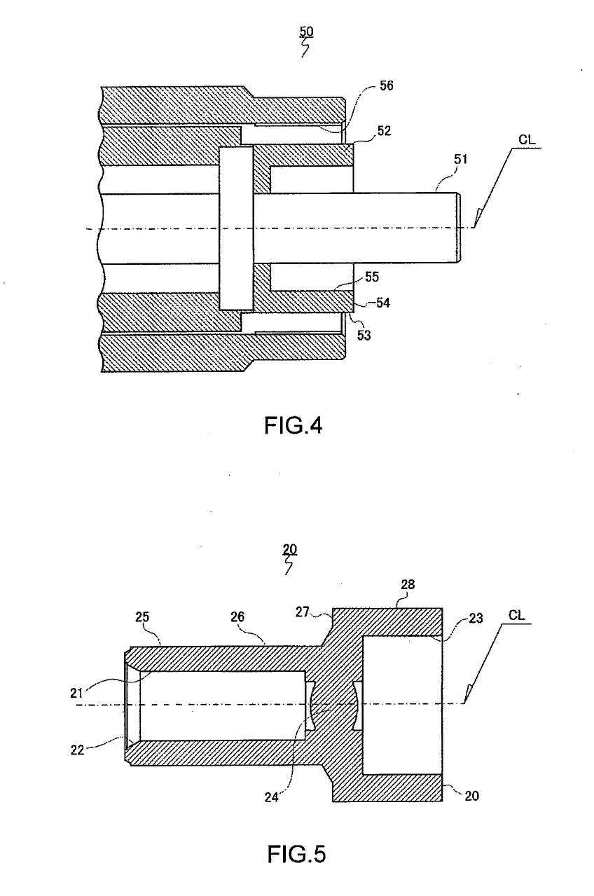

An optical fiber attachment hole 21 for attaching an optical fiber and a ferrule 51 (see FIG. 4) is provided in one end section (left end section in FIG. 1 and FIG. 3) of an optical fiber connector 10 in a direction along an axial line CL. The optical fiber attachment hole 21 is a hole that is open on one end and has an inner diameter that is almost the same as the outer diameter of the ferrule 51. On the opened end of the optical fiber attachment hole 21, a taper 22 is provided to smoothly guide the ferrule 51.

On the other hand, a photoelectric conversion element attachment hole 23 for holding a photoelectric conversion element package (not shown) housing a photoelectric conversion element is provided in the other end section (right end section in FIG. 1 and FIG. 3) of the optical fiber connector 10 in the direction along the axial line CL. The photoelectric conversion element attachment hole 23 is a hole that is open on one end.

A biconvex lens 24 is formed in the center section of the bottom surface of the optical fiber attachment hole 21 and the center section of the bottom surface of the photoelectric conversion element attachment hole 23. A center line of the optical fiber attachment hole 21 and an optical axis of the convex lens 24 are aligned with the axial line CL.

A stopper receiving section 31 that is a ring-shaped void is provided in the tip end section of the outer periphery of the optical fiber attachment hole 21. The stopper receiving section 31 is composed of a first guiding surface 32, a second guiding surface 25, and a bottom flat surface 33.

A male screw 34 that engages with a female screw 56 (see FIG. 4) of an optical fiber cable 50 (see FIG. 4) and is used to screw the optical fiber cable 50 onto the optical fiber connector 10 is formed in the outer periphery of the stopper receiving section 31.

A flange 35 is provided in the center section of the optical fiber connector 10. Through holes 36a and 36b for attachment using screws are provided in the flange 35.

[Configuration of Optical Fiber Cable]

FIG. 4 is a cross-sectional view of a front surface portion of an optical fiber cable having an optical fiber to be attached to the optical fiber connector shown in FIG. 1 to FIG. 3.

The tip end portion of the optical fiber within the optical fiber cable 50 is housed within the ferrule 51 to enable attachment to the optical fiber connector 10. The ferrule 51 has a circular cylindrical shape with a through hole in the center. The tip end portion of the optical fiber is placed within the through hole. The optical fiber rotates freely with the axial line CL as the center, in relation to the optical fiber cable 50. In addition, the optical fiber is held by the optical fiber cable 50 such as to be allowed movement in the axial line CL direction, such that the tip end of the ferrule 51 is in a predetermine position as a result of biasing by a spring member (not shown) in a natural state.

When the optical fiber is attached to the optical fiber connector 10, the ferrule 51 is inserted into the optical fiber attachment hole 21.

A ring-shaped stopper 52 (end surface 55) is formed in the optical fiber cable 50, in the outer peripheral portion of the ferrule 51. When the optical fiber cable 50 is attached to the optical fiber connector 10, an outer peripheral surface 53 and an inner peripheral surface 54 of the stopper 52 of the optical fiber cable 50 are respectively guided by the first guide surface 32 and the second guide surface 25 of the stopper receiving section 31, and the end surface 55 of the stopper 52 comes into contact with the bottom flat surface 33 of the stopper receiving section 31.

The female screw 56 that engages with the male screw 34 of the optical fiber connector 10 is formed in the outer periphery of the stopper 52.

[Components of Optical Fiber Connector]

As shown in FIG. 3, the optical fiber connector 10 is composed of two components: an optical system component 20 and a holder 30. The optical fiber connector 10 is assembled by the optical system component 20 being press-fitted into the holder 30.

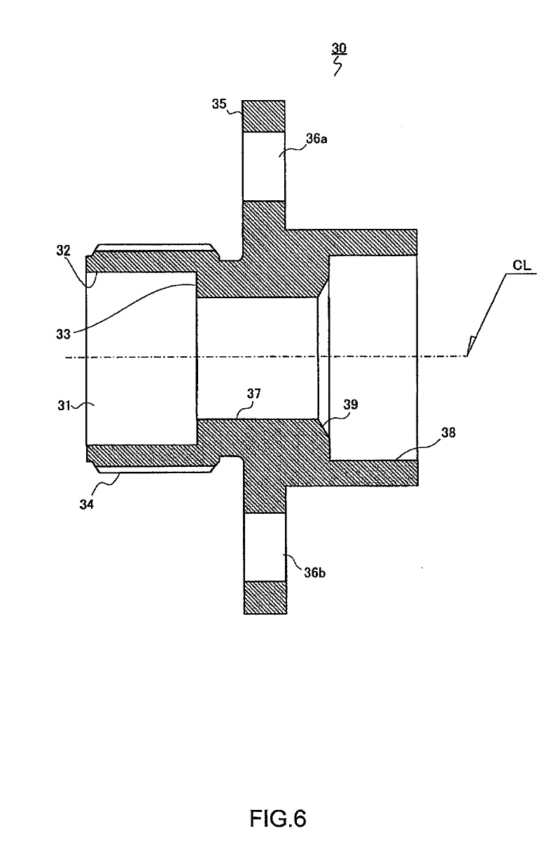

FIG. 5 is a front cross-sectional view of the optical system component 20 of the optical fiber connector 10. FIG. 6 is a front cross-sectional view of the holder 30 of the optical fiber connector 10.

The optical system component 20 is formed by a resin material having light transmittance, such as polyetherimide (PEI), polycarbonate (PC), or poly(methyl methacrylate) (PMMA), being injection-molded. The optical system component 20 has a simple shape and, therefore, can be easily formed by injection molding.

The optical system component 20 has an area related to the optical system, such as the optical attachment hole 21 and the convex lens 24.

The side surface of the optical system component 20 is a stepped cylinder. A first cylindrical section 26 for assembly to the holder 30 is formed in the outer periphery of the optical system component 20, around the optical fiber attachment hole 21. A second cylindrical section 28 having a larger outer diameter than the first cylindrical section 26 is formed in the outer periphery of the optical system component 20, around the photoelectric conversion element attachment hole 23. A stepped section 27 is provided between the first cylindrical section 26 and the second cylindrical section 28. The tip end section of the first cylindrical section 26 also serves as the second guide surface 25 for guiding the inner peripheral surface 54 of the stopper 52.

The holder 30 may be composed of the same resin material having light transmittance as the optical system component 20, or may be composed of a material differing from that of the optical system component 20, such as a resin material having superior mechanical strength characteristics like nylon or acetal, or a metal material such as steel.

The holder 30 has an area unrelated to the optical system, such as the stopper receiving section 31 (first guide surface 32 and bottom flat surface 33), the male screw 34, and the flange 35.

A through hole 37 for attaching the optical system component 20, and an escape hole 38 to prevent interference with the second cylindrical section 28 when the optical system component 20 is attached are formed in the holder 30.

The inner diameter of the through hole 37 is almost the same as the outer diameter of the first cylindrical section 26. A taper 39 is provided in the opened end of the through hole 37 on the escape hole 38 side to smoothly guide the optical system component 20. The inner diameter of the escape hole 38 is greater than the outer diameter of the second cylindrical section 28.

The optical fiber connector 10 is assembled by the first cylindrical section 26 of the optical system component 20 being inserted into the through hole 37 of the holder 30, and placing the stepped section 27 of the optical system component 20 in contact with the bottom surface of the escape hole 38 of the holder 30.

### Effects According to the Embodiment

As described above, according to the present embodiment, the optical fiber connector 10 is divided into the optical system component 20 of the area related to the optical system and the holder 30 of the area unrelated to the optical system, and the optical fiber attachment hole 21 and the convex lens 24 related to the optical system are integrally formed.

As a result, a centering operation for aligning the optical axis of the convex lens 24 and the center line of the optical fiber attachment hole 21 becomes unnecessary during assembly, and work efficiency can be improved from that of the past.

Even when the overall optical fiber connector 10 has a complex shape, the optical system component 20 of the area related to the optical system can be formed into a simple shape. Therefore, the mold for injection molding is easy to form, adjustment of coaxiality is facilitated, and accuracy can be increased.

Because the holder 30 is not related to the optical system, dimension accuracy can be relaxed, and manufacturing of the flange 35 can be facilitated.

Because the optical fiber attachment hole 21 and the convex lens 24 that are the optical system are independent from the flange 35, situations where load is directly applied to the optical fiber attachment hole 21 and the convex lens 24 are reduced. The optical fiber attachment hole 21 and the convex lens 24 do not easily become distorted, and decrease in coupling efficiency between the optical fiber and the photoelectric conversion element can be suppressed.

In addition, although the stopper receiving section 31 becomes ring-shaped after the optical system component 20 is assembled to the holder 30, in a state in which the optical system component 20 and the holder 30 are separated, the stopper receiving section 31 is cylindrical. Therefore, the bottom flat surface 33 can be easily processed by hand-reeling.

[Variations]

An instance in which the optical fiber connector 10 is assembled by the optical system component 20 being press-fitted into the holder 3 is described above. However, the present invention is not limited thereto, and other methods may be used for assembly. Hereafter, variations of the method for assembling the optical fiber connector 10 will be described with reference to the drawings.

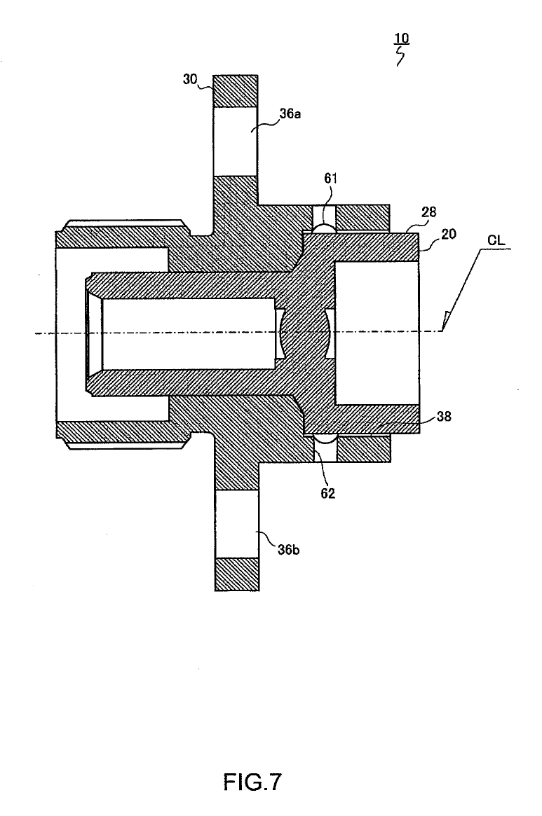

FIG. 7 is a front cross-sectional view of a variation 1 of the optical fiber connector according to the embodiment of the present invention. As shown in FIG. 7, in the variation 1, one or a plurality of projections 61 are provided in the second cylindrical section 28 of the optical system component 20. Through holes 62 of the same number as the number of projections 61 are provided in a portion on the side surface of the escape hole 38 of the holder 30 corresponding to the projections 61. Then, the projection 61 and the through hole 62 are fitted together, thereby enabling assembly of the optical fiber connector 10. A recess may be formed instead of the through hole 62.

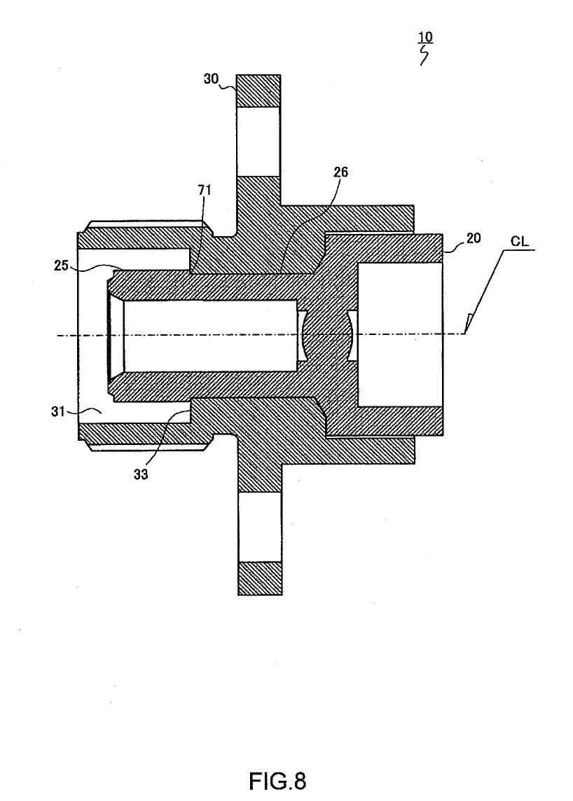

FIG. 8 is a front cross-sectional view of a variation 2 of the optical fiber connector according to the embodiment of the present invention. As shown in FIG. 8, in the variation 2, a step 71 is provided in the first cylindrical section 26 of the optical system component 20 such that the outer diameter of the tip end section 25 is slightly larger than the outer diameter of the center section. Then, the first cylinder section 26 engages with the bottom flat surface 33 of the stopper receiving section 31 of the holder 30 in the step 71 portion, thereby enabling assembly of the optical fiber connector 10. At this time, a taper may be formed in the through hole 37 of the holder 30 such that the inner diameter widens from the stopper receiver section 31 side to the escape hole 38 side.

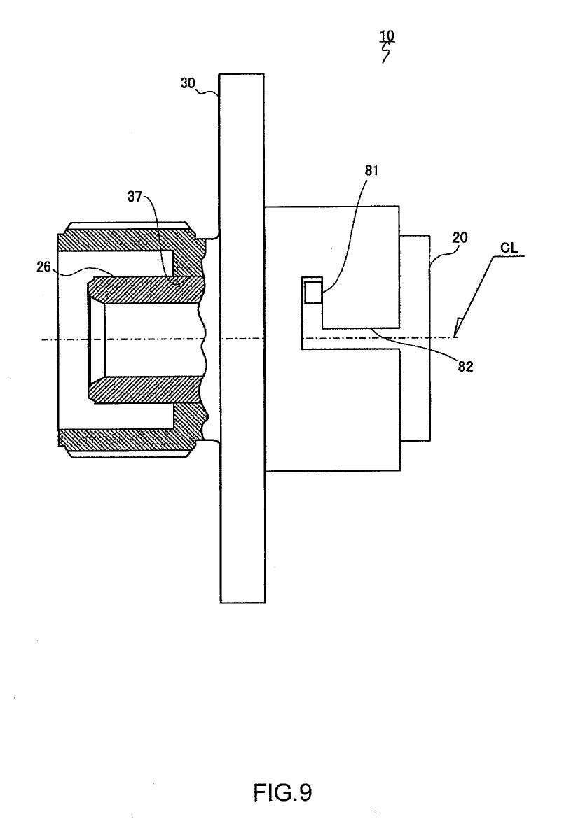

FIG. 9 is a cross-sectional view of the front surface portion of a variation 3 of the optical fiber connector according to the embodiment of the present invention. As shown in FIG. 9, in the variation 3, one or a plurality of projections 81 are provided in the second cylindrical section 28 of the optical system component 20, and an L-shaped notched section 82 is formed on the side surface of the escape hole 38 of the holder 30 in a portion corresponding to the projection 81. A taper is formed in the tip end portion of the notched section 82 such as to become thinner towards the tip. Then, the projection 81 is aligned at the position of the notched section 82, and the first cylinder section 26 of the optical system component 20 is inserted into the through hole 37 of the holder 30. The optical system component 20 is then rotated and the projection 81 becomes engaged with the tip end portion of the notched section 82, thereby enabling assembly of the optical fiber connector 10.

### INDUSTRIAL APPLICABILITY

The optical fiber connector of the present invention can be used in the field of optical communication by which optical signals are transmitted between an optical fiber and a photoelectric conversion element.

1. An optical fiber connector comprising:
a lens that optically couples an optical fiber and a photoelectric conversion element;
an optical fiber attaching section for housing a ferrule of the optical fiber; and
a flange for fixing the optical fiber connector to another device, wherein
the optical fiber connector is composed of
an optical system component including the optical fiber attaching section and the lens, and having an area related to an optical system, and
a holder including the flange and having an area unrelated to the optical system, and
the optical system component is assembled to the holder.

2. The optical fiber connector according to claim 1, wherein the optical system component is formed by a resin material having light transmittance being injection-molded.

3. The optical fiber connector according to claim 1 or 2, comprising:
a stopper receiving section that is a ring-shaped void that performs positioning of the optical fiber in an optical axis direction of the lens by a bottom surface coming into contact with a tip end of a ring-shaped stopper of the optical fiber, wherein
a first guide surface of the stopper receiving section that guides an outer peripheral surface of the stopper is composed of the optical system component, and
a second guide surface and the bottom surface of the stopper receiving section for guiding an inner peripheral surface of the stopper are composed of the holder.

4. The optical fiber connector according to claim 3, wherein:
the holder has a through hole having an inner diameter that is almost the same as an outer diameter of the second guide surface of the stopper receiving section of the optical system component; and
the optical system component is assembled to the holder by a second guide surface portion of the stopper receiving section of the optical system component being press-fitted into the through hole in the holder.

5. The optical fiber connector according to claim 3, wherein:
the optical system component has a projection;
the holder has a through hole or a recess; and
the optical system component is assembled to the holder by the projection in the optical system component being fitted in the through hole or the recess of the holder.

6. The optical fiber connector according to claim 3, wherein:
the second guide surface of the stopper receiving section of the optical system component has a step such that an outer diameter of a tip end section is slightly greater than an outer diameter of a center section;
the holder has a through hole having an inner diameter that is almost the same as the outer diameter of the second guide surface in the center section of the stopper receiving section of the optical system component; and
the optical system component is assembled to the holder by a second guide surface portion of the stopper receiving section of the optical system component being inserted into the through hole of the holder, and a step portion of the optical system component being engaged with a bottom surface portion of the stopper receiving section of the holder.

7. The optical fiber connector according to claim 3, wherein:
the optical system component has a projection;
the holder has an L-shaped notched section; and
the optical system component is assembled to the holder by the projection of the optical system component being inserted into the L-shaped notched section of the holder, the optical system component being rotated, and the projection of the optical system component being engaged with a tip end portion of the L-shaped notched section of the holder.
